(19) United States
(12) Patent Application Publication
(10) Pub. No.: US 2008/0292060 A1
(43) Pub. Date: Nov. 27, 2008

(54) X-ray imaging cassette for use in radiotherapy

(76) Inventors: Paul Leblans, Kontich (BE); Roland Mueller, Muenchen (DE); Wolfgang Kemp, Muenchen (DE)

Correspondence Address: NEXSEN PRUET, LLC, P.O. BOX 10648, GREENVILLE, SC, 29603, US

(21) Appl. No.: 11/981,356

(22) Filed: Oct. 30, 2007

Related U.S. Application Data
(60) Provisional application No. 60/881,978, filed on Jan. 22, 2007.

(30) Foreign Application Priority Data
Jan. 17, 2007 (EP) 07100645.6

(51) Int. Cl. G03B 42/02

(52) U.S. Cl. 378/167

(57) ABSTRACT

An X-ray imaging cassette having a cover side and a tube side is suitable for use in radiotherapy applications, if comprising, in admixture with storage phosphor particles in the phosphor layer of a loaded radiation image storage phosphor plate, metal or metal compound particles in form of powder, dispersed in a binder.

### CROSS-REFERENCE TO RELATED PATENT APPLICATIONS

This application claims the benefit of U.S. Provisional Application No. 60/881,978 filed Jan. 22, 2007, which is incorporated by reference. In addition, this application claims the benefit of European Application No. 07100645.6 filed Jan. 17, 2007, which is also incorporated by reference.

### FIELD OF THE INVENTION

The present invention relates to radiography and, more in particular, to image storage assemblies that are useful for oncology or radiotherapy imaging and to a radiation image recording and reproducing method.

### BACKGROUND OF THE INVENTION

Conventional medical diagnostic imaging obviates to obtain an image of a patients internal anatomy, exposing the patient to a dose of X-rays, as low as possible. So fast imaging speeds are realized by mounting a double-side coated silver halide radiographic element between a pair of fluorescent intensifying screens for image-wise exposure. Only a low percentage of the exposing X-radiation passing through the patient is directly absorbed by the silver halide emulsion layers, thereby forming a latent image within emulsion crystals of coated layers of said double-side coated radiographic element. Most of the X-radiation that participates in image formation is absorbed by phosphor particles within the fluorescent screens and fluorescent light, promptly emitted by such intensifying screens becomes absorbed by the silver halide emulsion layers of the radiographic element. Examples of radiographic elements, constructions for medical diagnostic purposes are provided by EP-A's 0 890 873, 0 930 527, 1 045 282, 1, 103 849, 1 217 428 and by U.S. Pat. Nos. 4,425,425; 4,425,426; 4,414,310; 4,803,150; 4,900,652; 5,252,442; 5,989,799; and 6,403,276.

Radiographic intensifying screens for industrial radiographic inspection are known to make use of copper, gold, tantalum and lead oxide as well as lead foils as convertor for said intensifying screens.

Radiation oncology is a field of radiology relating to the treatment of cancers, making use therefore of high energy X-radiation. This treatment is also known as “teletherapy”, making use of powerful, high-energy X-radiation machines (often linear accelerators) or Co-60 units to expose the cancerous tissues or tumors. The goal of such a treatment is to cure the patient by selectively killing the cancer while minimizing damage to surrounding healthy tissues.

Such treatment is commonly carried out using high energy X-radiation in a range from 4 to 25 MV. The X-radiation beams are very carefully mapped for intensity and energy. The patient is carefully imaged using a conventional diagnostic X-radiation unit, a CT scanner, and/or an MRI scanner to accurately locate the various tissues, healthy as well as cancerous, in the patient. Full knowledge of the treatment beam and the anatomy of the patient allows a person deciding what dose should be given, to determine where and for how long a time the treatment with X-ray irradiation should be directed, and to predict the radiation dose to be applied the patient.

Usually, this causes some healthy tissues to be overexposed. In order to reduce this effect, the person deciding what dose should be given specifies the shape of the beam that will be controlled by lead blockers at the source or “port” of the treatment device. This effectively acts as a substantially opaque block in front of parts of the patient's body, absorbing harmful X-rays that would damage healthy tissues.

Three distinct types of imaging are carried out in radiation oncology. The first type of imaging is called “simulation”. In this procedure, the patient is carefully imaged using a conventional diagnostic X-ray irradiation unit, a conventional radiographic imaging film system, a storage or stimulable phosphor system, or a digital system. In addition, a CT scanner and/or MRI scanner may be used to accurately locate the patient's anatomy. These procedures are essentially the same like those used in diagnostic radiography. They are carried out using energies in the range from 50 to 150 kV with low doses of radiation. These images provide detailed information on the patient's anatomy, and the location of the cancer relative to other body parts. From the simulation images and/or CT/MRI data, a person deciding what dose should be given, can determine where and for how long a time the treatment with X-ray irradiation should be directed. The person deciding what dose should be given, makes use of a computer in order to predict the X-ray irradiation dose for the patient. As this may lead to overexposure of some normal tissues, the person deciding what dose should be given will introduce one or more “blocks” or lead shields in order to block X-radiation from normal healthy anatomy. Alternatively, where available, the person deciding what dose should be given can shape the beam by specifying the positions for a so called multi-leaf collimator (MLC).

In order to determine and document that a treatment radiation beam is accurately directed and is effectively killing the cancerous tissues, two other types of imaging are carried out during the course of the treatment. “Portal radiography” is generally the term used to describe such radiotherapy in the MV energy ranges, conducted through an opening or port in a radiation shield. The first type of portal imaging is known as “localization” or “low dose portal” imaging in which a portal radiographic film is briefly exposed to the X-rays passing through the patient with the lead shields removed and then with the lead shields in place. Exposure without the lead shields provides a faint image of anatomical features that can be used as orientation references near the targeted feature while the exposure with the lead shields superimposes a second image of the port area. This process ensures that the lead shields are in the correct location relative to the patient's healthy tissues. Both exposures are made using a fraction of the total treatment dose, usually 1 to 4 monitor units out of a total dose of 45-150 monitor units, so that the patient receives less than 20 RAD's of radiation. If the patient and lead shields are accurately positioned relative to each other, the therapy treatment is carried out using a killing dose of X-radiation administered through the port. The patient typically receives from 50 to 300 RAD's, wherein 1 RAD corresponds with an energy absorption of 100 ergs per gram of tissue during treatment. The term “localization” thus refers to portal imaging that is used to locate the port in relation to the surrounding anatomy of the irradiated subject, wherein exposure times range from 1 to 10 seconds.

A second, less common form of “portal radiography” is known as “verification” or “high dose portal” imaging to verify the location of the cell-killing exposure. The purpose of this imaging is to record enough anatomical information to confirm that the cell-killing exposure was properly aligned with the targeted tissue. The imaging film/cassette assembly is kept in place behind the patient for the full duration of the treatment. The term “verification” thus refers to portal imaging that is used to record patient exposure through the port during radiotherapy. Typically exposure times range from 30 to 300 seconds. Verification films have only a single field, as the lead shields are in place, and are generally imaged at intervals during the treatment regime that may last for weeks. Portal radiographic imaging film, assembly and methods have been described, e.g., in U.S. Pat. Nos. 5,871,892 and 6,042,986; in which the same type of radiographic element can be used for both localization and portal or verification imaging.

A radiographic phosphor panel is known to contain a phosphor layer, wherein said phosphor is a crystalline material that responds to X-radiation on an image-wise basis. Radiographic phosphor panels can be classified, based on the type of phosphors, i.e., as prompt emission panels and as image storage panels.

Luminescent intensifying screens are the most common prompt emission panels and are generally used to generate visible light upon exposure to provide an image in radiographic silver halide materials. Storage phosphor panels, also called photostimulable phosphor screens, comprise storage phosphors that have the capability of storing latent X-ray images, wherein stored energy is set free later as emitted radiation energy by stimulation with a laser beam. Storage phosphors can be distinguished from the phosphors used in luminescent intensifying screens because the prompt emitting intensifying screen phosphors cannot store latent images for later emission as light becomes immediately released upon irradiation with X-rays. Various storage phosphors have been described, as e.g., in EP-A's 0 369 049, 0 399 662, 0 498 908, 0 751 200, 1 113 458, 1 137 015, 1 158 540, 1 316 969 and 1 316 970, as well as in U.S. Pat. Nos. 4,950,907; 5,066,864; 5,180,610; 5,289,512 and 5,874,744.

Storage phosphor systems for portal imaging as originally developed did not make use of a metal converter screen. However, this adversely affects image quality as pointed out in several publications as, e.g., by Wilenzink et al., Med. Phys., 14(3), 1987, pp. 389-392, and David et al., Med. Phys., 16(1), 1989, pp. 132-136. Subsequent teaching in this art e.g. suggests that a 1 mm thick copper metal plate would enhance contrast and image quality, as exemplified e.g. by Weiser et al., Med. Phys. 17(1), 1990, pp. 122-125, and Roehrig et al., SPIE, 1231, 1990, pp. 492-497. Soon thereafter, aluminum, copper, tantalum, and lead metal plates were considered with storage phosphor screens as disclosed by Barnea et al., Med. Phys., 18(3), 1991, pp. 432-438. The conventional understanding in the art is that even storage phosphor panels require relatively thick metal screens to improve image quality. However, the weight of such image storage assemblies is considerable and creates a problem for users in the medical imaging community. Light-weight cassettes provided with a front and a back panel consisting of light-weight material as e.g. aluminum/polypropylene/aluminum are clearly desired. Since the earliest teaching about the need for metal screens in image storage assemblies, the thickness of the metal screens has been set at 1 mm or more when copper is used and at 0.6 mm when lead is used. As set out in U.S. Pat. No. 6,428,207 a thickness of about 0.1 to 0.75 mm for copper and from about 0.05 to about 0.4 mm for lead was preferred, and even more preferably, the thickness was from about 0.1 to about 0.6 mm for copper screens and from about 0.05 to about 0.3 mm for lead screens, although it was consistently believed until then that thick metal screens were required to avoid overexposure, especially for portal imaging. Heavy conventional image storage assemblies indeed provided desired high contrast images, but because of the thick metal screens used in order to provide the desired imaging features, they were very heavy and difficult and unsafe to carry throughout medical facilities. Medical users have tolerated this disadvantage as thick metal plates were believed to be necessary for desired imaging properties, although light-weight cassettes would provide a better processing.

In order to provide light-weight cassettes, without laying burden upon desired image properties as image contrast and image definition, an X-ray imaging cassette has been developed as disclosed in US-Application 2005/023485 and EP-A-1 504 793, wherein said cassette has a cover side and a tube side, comprising in between a radiation image storage phosphor plate and a metal foil wherein said metal foil, acting as a filter sheet, having a thickness in the range from 0.10 to 0.60 mm, is composed of tungsten. In FIG. 1A thereof a relatively complex layer arrangement for the radiotherapy cassette has schematically been given, starting at the tube side (1) of the X-ray imaging cassette, where radiation impinges upon the cassette, a non-removable steel foil as a magnetic counterpart for the magnetic sheet (5), foil (2) being non-removable and attached to the cassette tube side (1), a tungsten filter foil (3) having a more preferred thickness between 0.10 and 0.30 mm in order to provide equilibrium at 6 MV, being in contact with the steel foil (2), and sandwiched between said steel foil (2) and storage phosphor plate (4), a removable X-ray image storage phosphor plate (4) as central part between cassette tube side cover and opposite cassette cover. Further layers present are a non-removable, but flexibly movable attached magnetic sheet (5) acting as a means for magnetically closing the cassette between said magnetic sheet and steel foil, non-removable and attached to the cassette tube side, (said strips bridging the magnetic sheet (5) and the next layer in the direction of the cover side; a non-removable lead (or lead compound) sheet (6), absorbing X-rays, having passed the X-ray image storage panel and a cassette cover (7) in contact with the non-removable lead (or lead compound) sheet.

Disadvantages of the method as applied therein are related with the fact that direct contact between metal plate as converter and storage phosphor plate as detector demands a difficult mechanical effort. Moreover in favor of sharpness flexibility of the convertor and of the detector pair would be highly appreciated, in order to make close contact with the radiated object in favor of image definition.

Moreover the production of metal plates is expensive and has a low yield. The production of thin, homogeneous metal plates of a high atomic number is nearly impossible as too heavy cassettes are difficult to handle for both, RTA and digitizer.

Apart from the disadvantage of weight of metal plates, another disadvantage is related with environmental pollution with heavy metals. It is therefore recommended to avoid direct contact of metal plates with the environment.

### SUMMARY OF THE INVENTION

As monitoring radiotherapy radiation which makes use of a commercially available CR system requires high energy radiation to be converted into secondary radiation, more particularly into secondary electrons, it is important to detect the secondary radiation close to the location of conversion in order to obtain a high sharpness (MTF), the conventional approach is to integrate a chemical element with high atomic number as a “converter” into the CR cassette. More particularly as a suitable alternative for a metal foil at the patient side of the cassette as applied in the prior art, wherein the CR screen, used as a “detector” is then pressed to the converter in order to obtain high sharpness, it has been found now to perform the integration of the “converter” into the CR “detector”, and more particularly the integration of powder converter into the CR storage phosphor detector.

According to the present invention an X-ray imaging cassette particularly suitable for use in applications for radiotherapy has a cover side and a tube side and comprises, in between said cover and tube side, comprising in between said cover side and said tube side, a radiation image storage phosphor plate comprising a layer wherein storage phosphor particles, as “detector” particles, are dispersed in a binder, and wherein in said layer, particles capable of absorbing high energy radiation, as “convertor” particles, are dispersed in admixture with said storage phosphor particles. Particles should, as claimed, be capable of absorbing or scattering high energy radiation, i.e. radiation in an energy in the range from 4 MV up to 50 MV, as applicable for radiotherapy applications.

In favor of providing a cassette for radiotherapy applications having a light-weight thanks to the absence of a heavy metal foil, and, as a consequence of absence of direct contact with the environment, having a lower hazardous environmental impact, a simplified layer material arrangement as a whole if compared with arrangements described in the prior art has been envisaged, without laying burden upon desired image properties as image contrast and image definition (sharpness).

As a solution an X-ray imaging cassette having a cover side and a tube side has advantageously been found to be suitable for use in radiotherapy applications, if comprising, in the phosphor layer of a loaded radiation image storage phosphor screen, plate or panel, a metal or metal compound in form of a powder, dispersed in a binder in admixture with storage phosphor particles as set out in claim 1. The radiation image storage phosphor plate having the features as described herein is also claimed.

Further advantages and embodiments of the present invention will become apparent from the following description and the claims.

### DETAILED DESCRIPTION OF THE INVENTION

In the following description a radiation image storage phosphor screen, plate or panel, is called a “phosphor plate” from now on.

According to the present invention an X-ray imaging cassette has a cover side and a tube side and comprises, in-between said cover and tube side, a (loaded) radiation image storage phosphor plate comprising a layer wherein storage phosphor particles are dispersed in a binder, and wherein in said layer, particles capable of absorbing high energy radiation are dispersed in admixture with said storage phosphor particles. Both said storage phosphor and said metal or metal compound are thus present in form of particles in said binder in the loaded storage phosphor plate of the cassette according to the present invention.

The storage phosphor layer in the plate of the cassette according to the present invention wherein both, fine metal and/or a metal compound “convertor” particles and storage phosphor “detector” particles are dispersed thus comprises, besides a binder and storage phosphor particles, particles capable of absorbing high energy radiation, thereby not emitting light in an ultraviolet or visible wavelength range, but emitting secondary electrons, secondary X-rays, secondary γ-rays or combinations thereof. The said particles essentially comprise at least one metal or metal compound, wherein said metal is selected from the group consisting of iridium, osmium, platinum, gold, tungsten, tantalum, hafnium, thallium, lead, bismuth, lutetium, thulium, erbium, rhodium, palladium, holmium, dysprosium, terbium, silver, gadolinium, ytterbium, samarium, molybdenum, cadmium, neodymium, cerium, praseodymium, niobium, tin, indium, lanthanum, antimony, europium, tellurium, nickel, copper, zirconium, cobalt, zinc and iron.

Preferred embodiments of the storage phosphor plates in the cassette, and of the storage plate as such, according to the present invention are as follows:

said metal compound particles are selected from the group consisting of an oxide, a hydroxide, a halide, a sulfide, a carbide, a sulfate, and an alloy consisting of several of said metals and a co-precipitate of several of said compounds;

said metal or metal compound particles and said storage phosphor particles are present in the storage phosphor layer in an amount of at least 10 wt %;

said metal or metal compound particles and said storage phosphor particles have a packing ratio in the storage phosphor layer of at least 2 volume % or more;

said binder comprises an organic polymer material, and a ratio by weight of said admixture of phosphor and metal or metal compound particles versus binder, is in the range of 10:1 to 100:1;

said metal or metal compound particles and said storage phosphor particles have an average size, expressed as equivalent volume diameter, in the range from 0.3 μm to 20 μm;

said layer has a thickness in the range from 5 μm to 1,000 μm;

said storage phosphor is a phosphor having a lanthanide or lanthanide compound as an activator, and as a matrix compound at least one of an alkaline metal, an alkaline earth metal, an earth metal or a trivalent metal, or a combination thereof, wherein said storage phosphor advantageously is a phosphor having europium or a europium compound as an activator, and as a matrix compound a barium fluorohalide or a cesium halide, halide advantageously being bromide.

Moreover according to the present invention the method of storing and reproducing a radiation image comprises the steps of:

mounting a loaded radiation image storage panel in an X-ray imaging cassette;

exposing to irradiation the said cassette by means of a radiation source having an energy in the range from 1 kV up to 50 MV, wherein said the object to be examined is situated between radiation source and cassette and wherein radiation is impinging first onto the tube side of the said cassette;

capturing said radiation by the radiation image storage panel of radiation having penetrated through an object, a radiation having been emitted by an object, or a radiation having been scattered or diffracted by an object in order to store energy of the applied radiation in form of a latent image on the image storage layer of the storage panel;

discharging the cassette by taking out the storage phosphor panel;

irradiating the image storage panel on the side of image storage layer with stimulating light in the visible or infrared range of the wavelength spectrum in order to excite the phosphor in the storage phosphor layer so that the energy stored in the storage layer in the form of a latent image is released in form of light;

collecting the light released from the storage phosphor layer by light-collecting means;

converting the collected light into a series of electric signals; and

producing an image corresponding to the latent image from the electric signals.

In a preferred embodiment according to the present invention the method comprises the step of exposing to irradiation the said cassette by means of a radiation source having an energy in the range from 4 MV up to 50 MV.

In the storage phosphor plate according to the present invention, the radiation converting particles are particles capable of absorbing radiation and emitting secondary electrons, and the particles contain at least one metal selected from the group consisting of iridium, osmium, platinum, gold, tungsten, tantalum, hafnium, thallium, lead, bismuth, lutetium, thulium, erbium, rhodium, palladium, holmium, dysprosium, terbium, silver, gadolinium, ytterbium, samarium, molybdenum, cadmium, neodymium, cerium, praseodymium, niobium, tin, indium, lanthanum, antimony, europium, tellurium, nickel, copper, zirconium, cobalt, zinc and iron.

The metal may be in the form of a elemental metal, a metal compound or a mixture thereof, e.g. in powder form. Examples of metal compounds include oxides as e.g., tungsten oxides —WO₃, WO₄ molybdenum oxide MoO₂, and tungsten carbide WC. The elemental metal, the metal compound and the mixture of both said elemental metal and said metal compound preferably contain the metal in an amount 45 wt % or more.

With respect to emission of secondary electrons, metals having large atomic numbers are preferred. Particularly preferred is tungsten. Convertor particles are thus preferably made of tungsten metal, a tungsten compound (e.g. WO₃) or a mixture thereof. Although it is difficult and accordingly gives rise to a high cost in order to make a tungsten foil, the screen of the invention can be produced at a relatively low cost since powdery tungsten is used instead of a tungsten foil, having disadvantages as set forth hereinbefore.

The metal or metal compound convertor particles preferably have an average size in the range of 0.3 μm to 20 μm. If the sizes are larger than 20 μm, the resultant radiation image often has such uneven density that image definition, i.e. sharpness, decreases.

The storage phosphor particles themselves preferably have an average size in the range of 0.3 μm to 20 μm.

A ratio of storage phosphor particles together with metal and/or metal compound particles versus polymer binder material generally is in the range of 10:1 to 100:1 by weight.

The binder preferably is an organic polymer material providing flexibility to the storage phosphor plate, especially when taken out of the cassette, read-out in a reader-imager and fed into the cassette again. Accordingly the surface of the storage plate should be made resistant to scratches as will further be discussed. Examples of organic polymer materials include synthetic polymers such as nitrocellulose, ethyl cellulose, cellulose acetate, polyvinyl butyral, linear polyester, polyvinyl acetate, vinylidene chloride-vinyl chloride copolymer, vinyl chloride-vinyl acetate copolymer, polyalkyl(meth)acrylate, polycarbonate, polyurethane, cellulose acetate butyrate, polyvinyl alcohol and thermoplastic elastomers; and natural polymers such as proteins (e.g., gelatin), polysaccharides (e.g., dextran) and gum arabic. These polymers may be cross-linked with a cross-linking agent.

The packing ratio of the storage phosphor particles and the metal and/or metal compound particles in the storage phosphor layer of the plate preferably is 50 vol. % or more, and is more preferably even 75 vol. % or more. Therein a ratio of the storage phosphor particles, together with the metal or metal oxide particles, and the binder, former to later, generally is in the range of 10:1 to 100:1 by weight.

The thickness in the plate of the storage phosphor layer, loaded with storage phosphor and metal (compound) convertor particles depends on penetrating power of radiation applied in radiotherapy applications, but generally is in the range of 5 μm to 3,000 μm and more preferably 5 μm to 1,000 μm.

As suggested hereinbefore, the flexible storage phosphor plate should be protected against scratches and wear and thus requires having various auxiliary layers, such as a protective layer. Whereas said protective layer is required at one side only for plates wherein the loaded storage phosphor layer is supported by a support, a self-supporting loaded storage phosphor plate requires protection at both sides of the said plate.

The support, if present, generally is a flexible or rigid sheet or film having a thickness of 50 μm to 3 mm. Examples of materials for the support include resins such as polyethylene terephthalate, polycarbonate, polyethylene naphthalate, acrylic resin, vinyl chloride resin, polyethylene and polyurethane, baryta paper, resin-coated paper, ordinary paper, wood, and metals and alloys such as iron and aluminum. On the support surface on which the loaded storage phosphor layer should applied, auxiliary layers such as a subbing layer and an electro-conductive layer can be formed. Further, many fine concaves and convexes may be formed on the surface of the said support. For rigid supports or substrates epoxy resin fiber and carbon fiber is a preferred material.

Onto that support, the loaded storage phosphor layer comprising besides the storage phosphor detector particles, the metal or metal compound convertor particles are applied. In order to get convertor and detector in a suitable admixture dispersion, mixture of detector and convertor particles, together with the binder are dispersed or dissolved in an appropriate organic solvent in order to prepare a coating dispersion. A ratio by weight between metal or metal compound convertor and storage phosphor detector particles on one hand and binder at the other hand generally is in the range from 10:1 to 100:1, and in a more preferred embodiment in the range from 10:1 to 50:1.

Examples of solvents include lower aliphatic alcohols, chlorinated hydrocarbons, ketones, esters, ethers, and mixtures thereof. The coating dispersion may contain various additives such as a dispersing agent, a plasticizer for enhancing bonding capability between binder and particles present in the loaded layer, a hardening agent, a cross-linking agent and, optionally, an anti-yellowing agent for preventing the loaded layer from undesirable coloring. The coating dispersion thus prepared is then evenly spread on a support surface, making use of coating means, and is dried in order to form the loaded phosphor layer.

The thickness of the loaded storage phosphor layer is determined according to various conditions such as characteristics of the desired plate, properties of the convertor particles and of the detector particles respectively, the mixing ratio between the binder and the detector and convertor particles, but generally such a layer has a thickness in the range of 5 to 1,000 μm, and more preferably in the range of 10 to 500 μm. In a more particular application such as verification imaging, wherein sharpness as such is not so important because high energy radiation creates unsharp images due to scattering effects at the high energy exposure levels, but wherein noise in the image is very important because this application has typically a low contrast, it is more advantageous to absorb the emission light instead of absorbing the stimulation light. Thereby sharpness is less affected and the more important noise perception is clearly reduced, than in case of absorbing stimulation light to a greater extent. As on the other hand the high exposure doses acquire either insensitive plates or readers that can be set very insensitive, making plates insensitive can be done by coating thinner phosphor layers but in that case homogeneity of the image is not acceptable because the coating techniques used for coating solutions having viscosities of up to 10000 mPas are not able to provide thin homogeneous layers. In order to provide layers having excellent mechanical properties, it is recommended to provide thicker layers prepared by “diluting” the phosphor particle concentration in the layers. Use of dyes, pigments or particles having a high molecular or atomic weight in the phosphor layer, and, more particularly of dyes that absorb the emission light, thus leads to insensitive plates that still have a good homogeneity. Particles having no storage phosphor properties, but a specific gravity higher than that of the storage phosphor particles are moreover recommended. Particle sizes not greater than the phosphor particle size are recommended, i.e. ratios of particle sizes of non-stimulable to particles of storage phosphor particle sizes of less than 0.8 and more preferably ratios of less than 0.5.

The thus produced layer may be compressed by means of, for example, a calendering machine so that the packing ratio of the particles in the layer is further increased. In a particular embodiment such a layer may, after calandering, be torn off the support, more particularly when before measures have been taken in order to get no particularly good adhesion between support and loaded layer in order to prepare a self-supporting loaded layer.

The loaded layer may be a single layer, but two or more sub-layers may be present if desired. Sub-layers may differ in particle type (detector and/or convertor particles), in particle composition or in particle size, as well as in ratios, usually expressed by weight, between detector and convertor particle types and between particles and binder. The layer loaded with detector and convertor particles may be present in contact with the support, or alternatively an intermediate layer between support and loaded layer may be present. Such an intermediate layer may e.g. be formed before on another substrate, e.g. a temporary support, may be peeled off and may then be fixed on the support or on another, e.g. auxiliary layer with an adhesive. In another embodiment the loaded layer may be overcoated with a supplemental layer of e.g. convertor particles only, or may even be present as a sandwiched layer between two supplemental convertor loaded layers.

In a first approach the ratio between converter material and storage medium is constant over the detector surface. By modeling the local ratio, the supplier can however provide a certain region or regions of interests. Storing particles may be selected for particular applications.

As another application compensation of the inhomogeneity of the X-ray equipment may be arranged by a providing a dedicated profile of the converter particles in the imaging plate.

Forming regions of interest, e.g. in the middle of an imaging plate, is also possible.

In a further embodiment a protective layer is preferably provided to ensure good handling of the loaded plate and in order to avoid deterioration while transporting said plate as already suggested before. Preferably, the protective layer is chemically stable, physically strong, and is sufficiently high moisture proof in order to protect the screen from chemical deterioration and physical damage. Protective layers may be provided by coating the layer with a solution in which a transparent organic polymer is dissolved in an appropriate solvent. In another embodiment an organic polymer film, prepared before, can be applied with an adhesive, inorganic or organic compounds may be applied by vapor deposition or spray-coating onto the loaded layer, whether or not protected by an auxiliary layer beforehand. Various additives may be added to the protective layer: examples thereof include a slipping agent as e.g., perfluoro-olefin resin and silicone resin and a cross-linking agent as e.g., polyisocyanate, without however been limited thereto. The thickness of the protective layer is generally in the range from 1 μm to 20 μm, and more preferably in the range of 1 to 10 μm. Fluoro-resin layers may be provided on the protective layer in order to enhance resistance to stain.

The cassette and the radiation image-forming method utilizing the loaded storage phosphor plate of the invention are further explained in detail hereinafter.

The radiographic cassette may be in form of a planar box, a body and a lid, which are partly combined so that the lid can be opened or closed. On the bottom of the body and on the inside surface of the lid, loaded storage phosphor plates may be fixed or placed. Body and lid of the cassette may be made of light-shielding but highly radiation-transmittable material such as aluminum, bakelite, amorphous carbon or carbon fiber reinforced material.

The radiographic cassette may be in form of a light-shielding bag type radiographic cassette, wherein the plates may be placed and wherein an opening of the bag is generally closed by being folded up in order to prevent light from coming into the bag. Cassettes are not restricted to the previous embodiments, as e.g., if required, shock-absorbing material may be provided between the loaded plate and the casing body and between the plate and the lid.

In the radiotherapy application a (loaded) storage phosphor plate is generally encased in at least one of the cassette types as described hereinbefore. In the radiotherapy application method, the cassette may be deformed in order to form a curve, parallel to the outer surface of the part of the body to be treated. The radiation passes through the body part, comes into the cassette to reach the loaded storage phosphor plate and is partly absorbed thereby, wherein the detector (storage phosphor) particles absorb part of that radiation as well as the convertor (metal and/or metal compound) particles, which emit secondary electrons, to which the neighboring detector storage phosphor particles are moreover exposed. Stored energy is then read-out in a digitizer, after taking the loaded storage phosphor plate out of the cassette. Read-out procedures are well-known in the field of photostimulable phosphor plates and no particular apparatus in order to perform read-out and erasure procedures are required. The radiation image-forming method of the invention not restricted to the mentioned embodiments either and various known embodiments can be adopted, depending on the particular application.

A cassette having an encasing, made of flexible material such as plastics, rubber or black paper, without being limitative, may further be in favor of simultaneous deformation of storage phosphor plate and cassette. Depending on the application an indication may be present, on the cassette, as well as on the loaded storage phosphor plate in order to know what side is the tube side. Such an indication may be detected directly by viewing (e.g. at the outside of the cassette, before starting the application) or indirectly by mechanical, electromechanical or electronic detection, more particularly for the packed loaded storage phosphor plate.

### EXAMPLES

While the present invention will hereinafter be described in connection with preferred embodiments thereof, it will be understood that it is not intended to limit the invention to those embodiments.

Since a cassette for radiotherapy makes use of a tungsten foil having a thickness, i.e. effective electron diffusion length, of 0.2 mm, other solution parameters for that RT application are:
typical Speed Class: 100,
typical root-compressed signal: 3600 SAL (SAL=scan average level),
IP sensitivity: 1% of GENRAD IP (general radiography imaging plates),
typical beam quality =6 MeV.

Assuming that pair production (proportional “number of nuclei”×“atomic number”²×In “Energy”) provides a dominant contribution to the conversion and that all of the converted electrons escape from the tungsten foil, i.e. with an infinite diffusion length, the signal per “gamma photon” can be calculated in arbitrary units (a.u.).

Making use of this number, mixing of the CR phosphor with different materials and calculating an equivalent thickness of the converter admixture leads to following results, provided that for such a calculation some approaches are necessary.

First of all, many converted electrons reach the CR phosphor as in the current situation and the fact that the converter is not in between X-Ray source and detector as well as the fact that diffusion length might not be infinite, may cause problems.

Moreover the admixture attenuates none of both, nor laser neither stimulated light.

Since the accuracy of the approximations is unknown, it is advisable to target a medium SAL (scanning average level) and a medium SC (speed class) so that the gain can be adjusted in both directions.

It has been assumed that the tungsten foil in the current product blocks the scattered electrons out of the tube side of the cassette. In a first approach no means to block this radiation was introduced.

In order to check how much the realistic situation differs from the approximation set forth above, image plates containing tungsten powder of defined equivalent thickness were prepared.

In the Tables 1 and 2 equivalent thicknesses for simulation and for practical plates have been set forth.

As a particular advantageous effect of the present invention a flexible and easily applicable radiotherapy application with CR digitizers is offered. Besides cost effective and weight reduction effects, applicability in more flexible, new “slit type” cassette is a highly appreciated improvement.

Such a plate is suitable for use in flexible CR applications, where ultra hard radiation like in radiotherapy is used.

The new “slit type” cassette comes with the new digitizers DX-S® and CR30®. This new cassette generation was developed for pure machine handling and thus has its loading opening, respectively lid, at its narrow side. The new cassettes can be loaded/unloaded in almost every orientation using rigid storage plates (DX-S). For flexible applications like in CR30®, those cassettes are equipped with a drawer in order to load them in a normally horizontal orientation.

With these new cassettes however, the advantage to bring the converter metal sheet in close contact to the image plate, like performed with the CR cassettes opening like a book, has gone.

As there was no solution provided in the new cassette design yet in order to fulfill the contact requirement properly, this exactly has initiated the invention at hand.

In the Table 1 and in the Table 2, plates used for effective “treatment” and for “simulation” (before treatment) respectively have been represented with their different embodiments, indicated as Inventive Embodiment 1 up to Inventive Embodiment 4, and have been compared with the current situation, making use of a tungsten foil and represented in the Tables 1 and 2 as comparative example. So powders of tungsten oxide, calcium tungstate containing 80.6 wt % of WO₃, gadolinium oxysulphide and tungsten in powdery form, having particles from 5 μm up to 10 μm, have respectively been admixed with the storage phosphor in dispersed form and coated in a storage phosphor panel layer.

Besides the visual color, the effective electron diffusion length (EEDL) and the atomic numbers of the elements present in the metal (oxide) powders have been given.

From coated amounts the “Number of molecules per sq.m.” has been calculated. For Speed Classes (SC) “100”, “200” and “300” (see Table 1) and Speed Classes (SC) “50”, “100”, “150” and “200” (see Table 2); Scan Average Levels (SAL) “1800” and “3600” and an Image Plate Sensitivity (Sensip) of “0.01” (treatment plates Table 1) and a Sens_{IP} “1.1” (simulation plates Table 2), expressed as a relative figure with respect to the Genrad IP, the signal per X-Ray quantum (in a.u.=arbitrary units) has been calculated (for an Energy E of 6 MeV—see “beam quality E” in both Tables) from the formula:

$$\frac{signal}{X \text{-} Ray quantum} = \frac{{( SAL \text{/} 1800 )}^{2}}{{Sens}_{IP} \cdot S C \cdot {n}_{molecules} \cdot {\sum }_{atoms} {n}_{atom} \cdot {Z}_{atom}^{2} \cdot ln ( E [ MeV ] )}$$

From the Tables 1 and 2 hereinafter, it is concluded that phosphor panels used in a cassette for radiotherapy, according to the present invention, provide ability to give same signals per X-ray quantum as for tungsten foils used in combination with a storage phosphor panel, described in published US-Application 2005/0023485, which is incorporated herein by reference.

Moreover thanks to the absence of a heavy metal foil in the simplified layer material arrangement as a whole in the light-weight cassette, and, as a consequence of absence of direct contact with the environment, having a lower hazardous environmental impact, the objects of the present invention in applications for radiotherapy are fully met, the more as desired image properties as image contrast and image definition are attained as envisaged.

Having described in detail preferred embodiments of the current invention, it will now be apparent to those skilled in the art that numerous modifications can be made therein without departing from the scope of the invention as defined in the appending claims.

TABLE 1
Equivalent thickness for treatment plates

| | | Inventive | Inventive | Inventive | Inventive |
|---|---|---|---|---|---|
| Example | Comparative | Embodiment 1 | Embodiment 2 | Embodiment 3 | Embodiment 4 |
| Description | Tungsten foil | Powder tungsten | Powder CaWO₄ | Powder Gd₂O₂S | Powder tungsten |
| | | (VI) -oxid WO₃ | | | |
| Color | white | citreous | white | white | glossy |
| EEDL | 0.2 mm | 0.082 mm | 0.079 mm | 0.089 mm | 0.067 mm |
| Density | 19250 kg/m³ | 7160 kg/m³ | 5700 kg/m³ | 7300 kg/m³ | 19250 kg/m³ |
| Molecular mass | 183.84 g/mol | 231.85 g/mol | 287.92 g/mol | 394.63 g/mol | 183.84 g/mol |
| Atomic | 74 | 74 | 74 | 64 | 74 |
| number Z₁ | | | | | |
| 1: Quantity | 1 | 1 | 1 | 2 | 1 |
| in particle | | | | | |
| Atomic | | 8 | 8 | 8 | |
| number Z₂ | | | | | |
| 2: Quantity | | 3 | 4 | 2 | |
| in particle | | | | | |
| Atomic | | | 20 | 20 | |
| number Z₃ | | | | | |
| 3: Quantity | | | 1 | 1 | |
| in particle | | | | | |
| Speed Class | 100 | 200 | 300 | 200 | 300 |
| Average Signal | | | | | |
| (SAL) | | | | | |
| IP | 3600 | 1800 | 1800 | 1800 | 3600 |
| Sensitivity | 0.01 | 0.01 | 0.01 | 0.01 | 0.01 |
| Number of | 1.26E+25 l/m² | 1.52E+24 l/m² | 9.39E+23 l/m² | 9.90E+23 l/m² | 4.20E+24 l/m² |
| molecules | | | | | |
| Beam | 6 MeV | 6 MeV | 6 MeV | 6 MeV | 6 MeV |
| Quality E | | | | | |
| Signal per | 3.23E−29 a.u. | 3.23E−29 a.u. | 3.23E−29 a.u. | 3.23E−29 a.u. | 3.23E−29 a.u. |
| X-Ray | | | | | |
| quantum | | | | | |

TABLE 2
Equivalent thickness for simulation plates

| | | Inventive | Inventive | Inventive | Inventive |
|---|---|---|---|---|---|
| Example | Comparative | Embodiment 1 | Embodiment 2 | Embodiment 3 | Embodiment 4 |
| Description | Tungsten foil | Powder tungsten | Powder CaWO₄ | Powder Gd₂O₂S | Powder tungsten |
| | | (VI) -oxid WO₃ | | | |
| Color | white | citreous | white | white | glossy |
| EEDL | 0.2 mm | 0.082 mm | 0.079 mm | 0.089 mm | 0.013 mm |
| Density | 19250 kg/m³ | 7160 kg/m³ | 5700 kg/m³ | 7300 kg/m³ | 19250 kg/m³ |
| Molecular mass | 183.84 g/mol | 231.85 g/mol | 287.92 g/mol | 394.63 g/mol | 183.84 g/mol |
| Atomic | 74 | 74 | 74 | 64 | 74 |
| number Z₁ | | | | | |
| 1: Quantity | 1 | 1 | 1 | 2 | 1 |
| in particle | | | | | |
| Atomic | | 8 | 8 | 8 | |
| number Z₂ | | | | | |
| 2: Quantity | | 3 | 4 | 2 | |
| in particle | | | | | |
| Atomic | | | 20 | 20 | |
| number Z₃ | | | | | |
| 3: Quantity | | | 1 | 1 | |
| in particle | | | | | |
| Speed Class | 50 | 100 | 150 | 100 | 200 |
| Average Signal | | | | | |
| (SAL) | | | | | |
| IP | 3600 | 1800 | 1800 | 1800 | 1800 |
| Sensitivity | 1.1 | 1.1 | 1.1 | 1.1 | 1.1 |
| Number of | 1.26E+25 l/m² | 1.52E+24 l/m² | 9.39E+23 l/m² | 9.90E+23 l/m² | 7.88E+23 l/m² |
| molecules | | | | | |
| Beam | 6 MeV | 6 MeV | 6 MeV | 6 MeV | 6 MeV |
| Quality E | | | | | |
| Signal per | 5.88E−31 a.u. | 5.88E−31 a.u. | 5.88E−31 a.u. | 5.88E−31 a.u. | 5.88E−31 a.u. |
| X-Ray | | | | | |
| quantum | | | | | |

What is claimed is:

1. An X-ray imaging cassette having a cover side and a tube side, comprising in between said cover side and said tube side, a radiation image storage phosphor plate comprising a layer wherein storage phosphor particles are dispersed in a binder, and wherein in said layer, particles capable of absorbing high energy radiation are dispersed in admixture with said storage phosphor particles.

2. Cassette according to claim 1, wherein said particles capable of absorbing high energy radiation are metal or metal compound particles, wherein said metal is selected from the group consisting of iridium, osmium, platinum, gold, tungsten, tantalum, hafnium, thallium, lead, bismuth, lutetium, thulium, erbium, rhodium, palladium, holmium, dysprosium, terbium, silver, gadolinium, ytterbium, samarium, molybdenum, cadmium, neodymium, cerium, praseodymium, niobium, tin, indium, lanthanum, antimony, europium, tellurium, nickel, copper, zirconium, cobalt, zinc and iron.

3. Cassette according to claim 2, wherein said metal compound particles are selected from the group consisting of an oxide, a hydroxide, a halide, a sulphide, a carbide, a sulphate, and an alloy consisting of two of said metals and a co-precipitate of two of said compounds.

4. Cassette according to claim 2, wherein said metal or metal compound particles and said storage phosphor particles are present in the storage phosphor layer in an amount of at least 10 wt %.

5. Cassette according to claim 3, wherein said metal or metal compound particles and said storage phosphor particles are present in the storage phosphor layer in an amount of at least 10 wt %.

6. Cassette according to claim 2, wherein said metal or metal compound particles and said storage phosphor particles have a packing ratio in the storage phosphor layer of 2 volume % or more.

7. Cassette according to claim 3, wherein said metal or metal compound particles and said storage phosphor particles have a packing ratio in the storage phosphor layer of 2 volume % or more.

8. Cassette according to claim 2, wherein said binder comprises an organic polymer material and wherein a ratio by weight of said admixture of phosphor and metal or metal compound particles versus binder is in the range of 10:1 to 100:1.

9. Cassette according to claim 3, wherein said binder comprises an organic polymer material and wherein a ratio by weight of said admixture of phosphor and metal or metal compound particles versus binder is in the range of 10:1 to 100:1.

10. Cassette according to claim 2, wherein said metal or metal compound particles and said storage phosphor particles have an average size, expressed as equivalent volume diameter, in the range from 0.3 μm to 20 μm.

11. Cassette according to claim 3, wherein said metal or metal compound particles and said storage phosphor particles have an average size, expressed as equivalent volume diameter, in the range from 0.3 μm to 20 μm.

12. Cassette according to claim 1, wherein said layer has a thickness in the range from 5 μm to 1,000 μm.

13. Cassette according to claim 1, wherein said storage phosphor is a phosphor having a lanthanide or lanthanide compound as an activator, and as a matrix compound at least one of an alkaline metal, an alkaline earth metal, an earth metal or a trivalent metal, or a combination thereof.

14. A radiation image storage phosphor plate comprising a layer wherein a storage phosphor is dispersed in a binder, and wherein in said layer, dispersed in admixture with storage phosphor particles, particles capable of absorbing high energy radiation are present.

15. Radiation image storage phosphor plate according to claim 14, wherein said particles capable of absorbing high energy radiation are metal or metal compound particles, wherein said metal is selected from the group consisting of iridium, osmium, platinum, gold, tungsten, tantalum, hafnium, thallium, lead, bismuth, lutetium, thulium, erbium, rhodium, palladium, holmium, dysprosium, terbium, silver, gadolinium, ytterbium, samarium, molybdenum, cadmium, neodymium, cerium, praseodymium, niobium, tin, indium, lanthanum, antimony, europium, tellurium, nickel, copper, zirconium, cobalt, zinc and iron.

16. Radiation image storage phosphor plate according to claim 14, wherein said storage phosphor is a phosphor having a lanthanide or lanthanide compound as an activator, and as a matrix compound at least one of an alkaline metal, an alkaline earth metal, an earth metal or a trivalent metal, or a combination thereof.

17. Radiation image storage phosphor plate according to claim 14, wherein said storage phosphor is a phosphor having a europium or a europium compound as an activator, and as a matrix compound a barium fluorohalide type phosphor or a cesium halide type phosphor.

18. Radiation image storage phosphor plate according to claim 14, wherein said halide is bromide.
